(19) United States
(12) Patent Application Publication
(10) Pub. No.: US 2013/0330811 A1
(43) Pub. Date: Dec. 12, 2013

(54) THERMAL CYCLER

(71) Applicant: Seiko Epson Corporation, Tokyo (JP)

(72) Inventor: Hiroshi Koeda, Suwa (JP)

(21) Appl. No.: 13/909,361

(22) Filed: Jun. 4, 2013

(30) Foreign Application Priority Data
Jun. 6, 2012 (JP) 2012-129309

(51) Int. Cl. B01L 7/00

(52) U.S. Cl. CPC B01L 7/52
USPC 435/283.1

(57) ABSTRACT

A thermal cycler includes: a fitting section for fitting a biochip; a first temperature setting section that sets the temperature of a first region of the biochip; a second temperature setting section that sets the temperature of a second region different from the first region to a temperature different from the first temperature setting section; a driving mechanism that changes a positional relationship between the first region and the second region with respect to the gravitational direction; and a control section that controls the driving mechanism, wherein the control section performs: a process of controlling the driving mechanism such that a first arrangement in which the first region is on the lower side of the second region with respect to the gravitational direction is kept for a first predetermined period.

### BACKGROUND

1. Technical Field

The present invention relates to a thermal cycler.

2. Related Art

In recent years, as a result of development of technologies utilizing genes, medical treatments utilizing genes such as genetic diagnosis or genetic therapy are drawing attention, and in addition, many methods utilizing genes in determination of breed varieties or breed improvement have also been developed in agricultural and livestock industries. As technologies for utilizing genes, technologies such as a PCR (Polymerase Chain Reaction) method are widely used. Nowadays, the PCR method has become an indispensable technology in elucidation of information on biological materials.

The PCR method is a method of amplifying a target nucleic acid by subjecting a solution (a reaction mixture) containing a nucleic acid to be amplified (a target nucleic acid) and a reagent to a thermal cycle. The thermal cycle is a process of subjecting a reaction mixture to two or more stages of temperatures periodically. In the PCR method, a method of performing a two- or three-stage thermal cycle is generally used.

In the PCR method, a chamber designed for performing a biochemical reaction called a tube or a chip for a biological sample reaction (a biochip) is generally used. However, in the method of the related art, there are problems that a large amount of a reagent or the like is required for the reaction, an apparatus is complicated in order to realize a thermal cycle required for the reaction, and it takes time to perform the reaction. Therefore, a biochip or a reaction apparatus for performing PCR accurately in a short time using a small amount of a reagent or a sample has been demanded.

In order to solve such a problem, JP-A-2009-136250 discloses a biological sample reaction apparatus that performs a thermal cycle by rotating a biochip filled with a reaction mixture and a liquid which is immiscible with the reaction mixture and has a specific gravity smaller than that of the reaction mixture (such as a mineral oil, hereinafter referred to as “liquid”) about an axis of rotation in the horizontal direction, thereby moving the reaction mixture.

In the biological sample reaction apparatus disclosed in JP-A-2009-136250, a reaction mixture is subjected to a thermal cycle by continuously rotating a biochip. However, the reaction mixture moves in a flow channel of the biochip along with the rotation, and therefore, in order to maintain the reaction mixture at a desired temperature for a desired period, it is necessary to devise the structure of the flow channel of the biochip, for example, to complicate the flow channel.

### SUMMARY

An advantage of some aspects of the invention is to provide a thermal cycler with which the control of a heating period is easy.

### Application Example 1

A thermal cycler according to this application example includes: a fitting section for fitting a biochip; a first temperature setting section that sets the temperature of a first region of the biochip; a second temperature setting section that sets the temperature of a second region different from the first region to a temperature different from the first temperature setting section; a driving mechanism that changes a positional relationship between the first region and the second region with respect to the gravitational direction; and a control section that controls the driving mechanism, wherein the control section performs: a process of controlling the driving mechanism such that a first arrangement in which the first region is on the lower side of the second region with respect to the gravitational direction is kept for a first predetermined period; and a process of controlling the driving mechanism such that a second arrangement in which the second region is on the lower side of the first region with respect to the gravitational direction is kept for a second predetermined period.

According to this application example, the position of the lowest point or the highest point of the biochip with respect to the gravitational direction is changed by switching over between the first arrangement and the second arrangement. By doing this, the reaction mixture moves in the biochip. Therefore, the reaction mixture placed in the biochip can be subjected to a thermal cycle. Further, a temperature condition can be easily set by providing the first temperature setting section and the second temperature setting section, each having a different temperature. Further, the reaction mixture placed in the biochip can be maintained at a predetermined temperature while the driving mechanism keeps the arrangement of the biochip in the first arrangement or the second arrangement. Accordingly, a thermal cycler capable of easily controlling a period in which the reaction mixture placed in the biochip is placed under the predetermined temperature condition can be realized.

### Application Example 2

In the thermal cycler according to the application example described above, it is preferred that the control section controls the driving mechanism such that the direction of rotation in the case of switching over from the first arrangement to the second arrangement is opposite to that in the case of switching over from the second arrangement to the first arrangement.

According to this application example, the direction of rotation by the driving mechanism in the case of switching over from the first arrangement to the second arrangement is opposite to that in the case of switching over from the second arrangement to the first arrangement, and therefore, a mechanism for reducing twisting of a wiring in the apparatus caused by the rotation is no longer required. Accordingly, a thermal cycler suitable for downsizing can be realized.

### BRIEF DESCRIPTION OF THE DRAWINGS

The invention will be described with reference to the accompanying drawings, wherein like numbers reference like elements.

FIGS. 1A and 1B are perspective views showing a thermal cycler according to an embodiment. FIG. 1A shows a state in which a lid is closed, and FIG. 1B shows a state in which the lid is opened.

FIG. 2 is an exploded perspective view of amain body of the thermal cycler according to the embodiment.

FIG. 3 is a cross-sectional view of a biochip according to the embodiment.

FIGS. 4A and 4B are schematic cross-sectional views showing the cross section taken along the line A-A in FIG. 1A of the main body of the thermal cycler according to the embodiment. FIG. 4A shows a first arrangement, and FIG. 4B shows a second arrangement.

FIG. 5 is a flowchart showing a procedure of a thermal cycling process using the thermal cycler according to the embodiment.

FIGS. 6A and 6B are perspective views showing a thermal cycler according to a modification example. FIG. 6A shows a state in which a lid is closed, and FIG. 6B shows a state in which the lid is opened.

FIG. 7 is a cross-sectional view of a biochip according to a modification example.

FIG. 8 is a schematic cross-sectional view showing the cross section taken along the line B-B in FIG. 6A of amain body of the thermal cycler according to the modification example.

FIG. 9 is a flowchart showing a procedure of a thermal cycling process according to Example 1.

FIG. 10 is a flowchart showing a procedure of a thermal cycling process according to Example 2.

FIG. 11 is a table showing a composition of a reaction mixture according to Example 2.

FIGS. 12A and 12B are tables showing results of a thermal cycling process according Examples. FIG. 12A shows the results of Example 1, and FIG. 12B shows the results of Example 2.

### DESCRIPTION OF EXEMPLARY EMBODIMENTS

Hereinafter, a preferred embodiment of the invention will be described in detail with reference to the accompanying drawings. The embodiment described below is not intended to falsely limit the contents of the invention described in the appended claims. In addition, all of the configurations described below are not necessarily essential constituent requirements of the invention. The drawings are for the purpose of illustration for the sake of convenience.

Hereinafter, a preferred embodiment of the invention will be described in the following order with reference to the accompanying drawings.

1. Embodiment
1-1. Structure of Thermal Cycler According to Embodiment
1-2. Thermal Cycling Process Using Thermal Cycler According to Embodiment
1-3. Effect of Thermal Cycler According to Embodiment

2. Modification Examples

3. Examples

Example 1. Shuttle PCR

Example 2. 1-step RT-PCR

### 1. EMBODIMENT

### 1-1. Structure of Thermal Cycler According to Embodiment

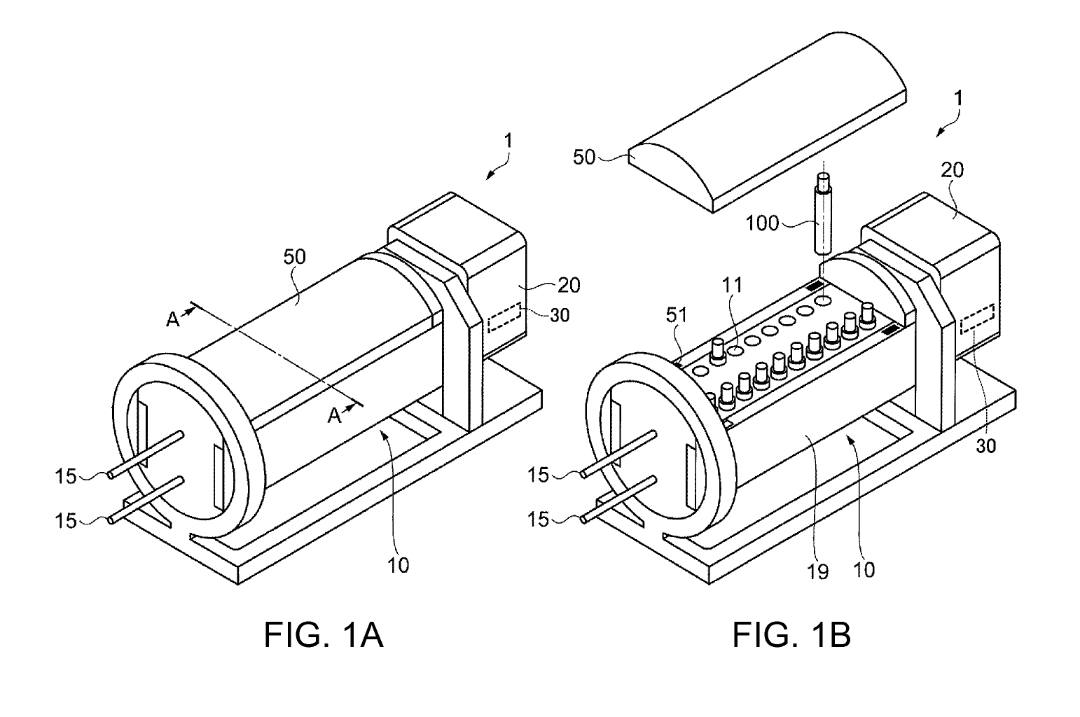

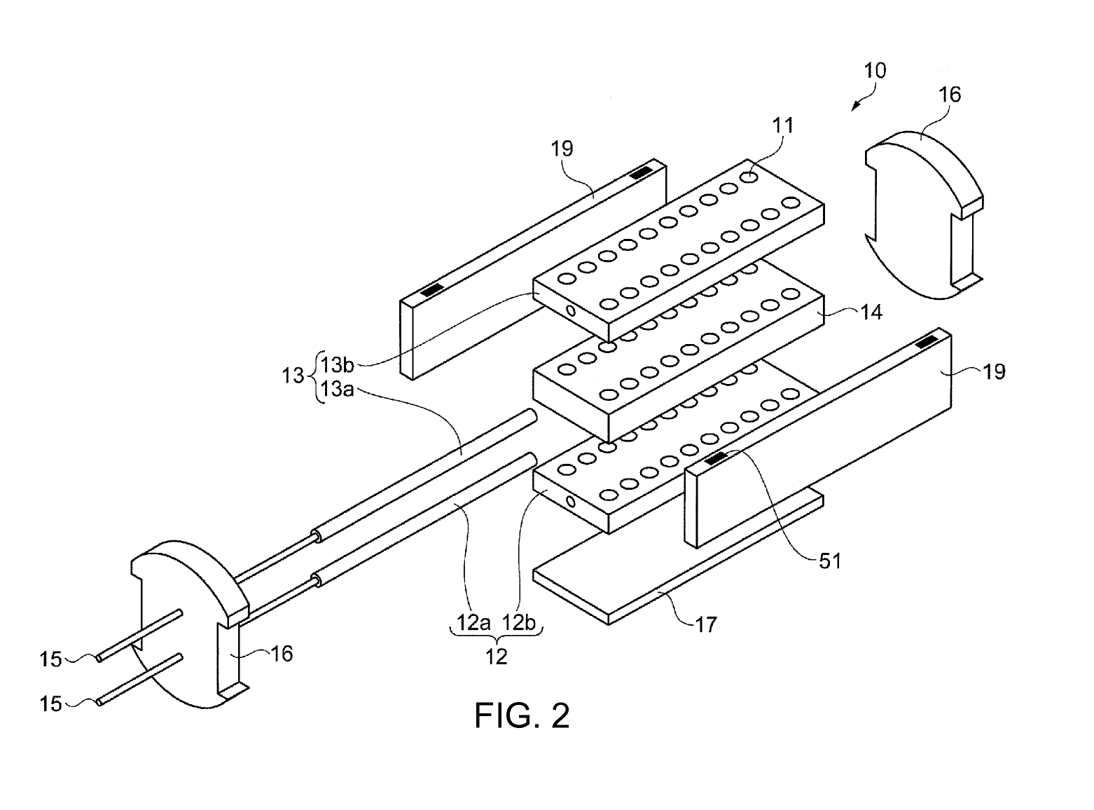

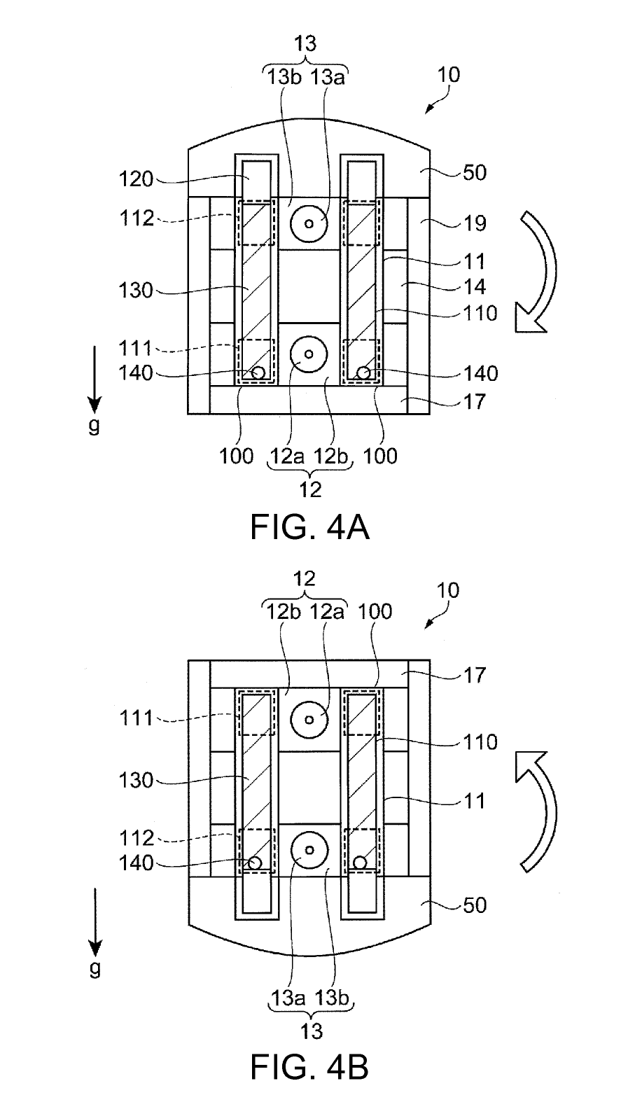

FIGS. 1A and 1B are perspective views showing a thermal cycler 1 according to an embodiment. FIG. 1A shows a state in which a lid 50 of the thermal cycler 1 is closed, and FIG. 1B shows a state in which the lid 50 of the thermal cycler 1 is opened and a biochip 100 is fitted in a fitting section 11. FIG. 2 is an exploded perspective view of a main body 10 of the thermal cycler 1 according to the embodiment. FIGS. 4A and 4B are schematic cross-sectional views showing the cross section taken along the line A-A in FIG. 1A of the main body 10 of the thermal cycler 1 according to the embodiment.

The thermal cycler 1 according to the embodiment includes the fitting section 11 for fitting the biochip 100, a first temperature setting section (e.g., a first heating section 12) that sets the temperature of a first region 111 of the biochip 100, a second temperature setting section (e.g., a second heating section 13) that sets the temperature of a second region 112 different from the first region 111 of the biochip 100 to a temperature different from the first temperature setting section, a driving mechanism 20 that changes a positional relationship between the first region 111 and the second region 112 with respect to the gravitational direction, and a control section 30 that controls the driving mechanism 20.

As shown in FIG. 1A, the thermal cycler 1 according to the embodiment includes the main body 10, the driving mechanism 20, and the control section 30. As shown in FIG. 2, the main body 10 includes the fitting section 11, the first heating section 12 (corresponding to the first temperature setting section), and the second heating section 13 (corresponding to the second temperature setting section). A spacer 14 is provided between the first heating section 12 and the second heating section 13. In the main body 10 of this embodiment, the first heating section 12 is disposed on the side of a bottom plate 17, and the second heating section 13 is disposed on the side of the lid 50. In the main body 10 of this embodiment, the first heating section 12, the second heating section 13, and the spacer 14 are fixed by a flange 16, the bottom plate 17, and a fixing plate 19.

The fitting section 11 is configured to fit the biochip 100, which will be described later. As shown in FIGS. 1B and 2, the fitting section 11 of this embodiment has a slot structure in which the biochip 100 is inserted and fitted, and is configured such that the biochip 100 is inserted into a hole penetrating through a first heat block 12b of the first heating section 12, the spacer 14, and a second heat block 13b of the second heating section 13. The number of the fitting sections 11 may be more than one, and in the example shown in FIG. 1B, twenty fitting sections 11 are provided for the main body 10.

The thermal cycler 1 of this embodiment preferably includes a structure in which the biochip 100 is held at a predetermined position with respect to the first heating section 12 and the second heating section 13. Accordingly, a predetermined region of the biochip 100 can be heated by the first heating section 12 or the second heating section 13. More specifically, as shown in FIGS. 4A and 4B, in a flow channel 110 constituting the biochip 100, which will be described later, a first region 111 can be heated by the first heating section 12 and a second region 112 can be heated by the second heating section 13. In this embodiment, a structure that defines the position of the biochip 100 is the bottom plate 17, and as shown in FIG. 4A, by inserting the biochip 100 to a position in contact with the bottom plate 17, the biochip 100 can be held at a predetermined position with respect to the first heating section 12 and the second heating section 13.

When the biochip 100 is fitted in the fitting section 11, the first heating section 12 heats the first region 111 of the biochip 100, which will be described later, to a first temperature. In the example shown in FIG. 4A, in the main body 10, the first heating section 12 is disposed at a position capable of heating the first region 111 of the biochip 100.

The first heating section 12 may include a mechanism that generates heat and a member that transfers the generated heat to the biochip 100. In the example shown in FIG. 2, the first heating section 12 includes a first heater 12a and the first heat block 12b. In this embodiment, the first heater 12a is a cartridge heater, and is connected to an external power source (not shown) through a conductive wire 15. The first heater 12a is inserted into the first heat block 12b, and the first heat block 12b is heated by heat generated by the first heater 12a. The first heat block 12b is a member that transfers heat generated by the first heater 12a to the biochip 100. In this embodiment, the first heat block 12b is an aluminum block.

Since the control of the temperature of the cartridge heater is easy, the temperature of the first heating section 12 can be easily stabilized by using the cartridge heater as the first heater 12a. Therefore, a more accurate thermal cycle can be realized. Since the thermal conductivity of aluminum is high, by forming the first heat block 12b from aluminum, the biochip 100 can be efficiently heated. Further, since uneven heating of the first heat block 12b hardly occurs, a thermal cycle with high precision can be realized. In addition, since processing of aluminum is easy, the first heat block 12b can be molded with high precision and the precision of heating can be enhanced. Accordingly, a more accurate thermal cycle can be realized.

The first heating section 12 is preferably in contact with the biochip 100 when the biochip 100 is fitted in the fitting section 11. Accordingly, when the biochip 100 is heated by the first heating section 12, heat generated by the first heating section 12 can be stably transferred to the biochip 100, and therefore, the temperature of the biochip 100 can be stabilized. In the case where the fitting section 11 is formed as a part of the first heating section 12 as in this embodiment, the fitting section 11 preferably comes into contact with the biochip 100. Accordingly, heat generated by the first heating section 12 can be stably transferred to the biochip 100, and therefore, the biochip 100 can be efficiently heated.

When the biochip 100 is fitted in the fitting section 11, the second heating section 13 heats the second region 112 different from the first region 111 of the biochip 100 to a second temperature different from the first temperature. In the example shown in FIG. 4A, in the main body 10, the second heating section 13 is disposed at a position capable of heating the second region 112 of the biochip 100. As shown in FIG. 2, the second heating section 13 includes a second heater 13a and the second heat block 13b. The second heating section 13 is configured in the same manner as the first heating section 12 except that the region of the biochip 100 to be heated and the heating temperature are different from those for the first heating section 12.

In this embodiment, the temperatures of the first heating section 12 and the second heating section 13 are controlled by a temperature sensor (not shown) and the control section 30, which will be described later. The temperatures of the first heating section 12 and the second heating section 13 are preferably set so that the biochip 100 is heated to a desired temperature. In this embodiment, by controlling the first heating section 12 at the first temperature and the second heating section 13 at the second temperature, the first region 111 of the biochip 100 can be heated to the first temperature, and the second region 112 can be heated to the second temperature. The temperature sensor in this embodiment is a thermocouple.

The driving mechanism 20 is a mechanism that changes a positional relationship between the first region 111 and the second region 112 with respect to the gravitational direction. In this embodiment, the driving mechanism 20 is a mechanism that drives the fitting section 11, the first heating section 12, and the second heating section 13. Further, in this embodiment, the driving mechanism 20 includes a motor (not shown) and a drive shaft (not shown), and the drive shaft is connected to the flange 16 of the main body 10. The drive shaft in this embodiment is provided perpendicular to the longitudinal direction of the fitting section 11, and when the motor is activated, the main body 10 is rotated about the drive shaft as the axis of rotation.

The thermal cycler 1 of this embodiment includes the control section 30. The control section 30 controls the driving mechanism 20. The control section 30 performs a process of controlling the driving mechanism 20 such that a first arrangement in which the first region 111 is on the lower side of the second region 112 with respect to the gravitational direction is kept for a first predetermined period, and a process of controlling the driving mechanism 20 such that a second arrangement in which the second region 112 is on the lower side of the first region 111 with respect to the gravitational direction is kept for a second predetermined period. Specific examples of the control by the control section 30 will be described later.

The control section 30 may control at least one of, for example, the first temperature, the second temperature, the first period, the second period, and the number of thermal cycles, which will be described later. In the case where the control section 30 controls the first period or the second period, the control section 30 controls the operation of the driving mechanism 20, thereby controlling the period in which the fitting section 11, the first heating section 12, and the second heating section 13 are held in a predetermined arrangement. The control section 30 may have mechanisms different in each item to be controlled, or may be a section which controls all items collectively.

The control section 30 in the thermal cycler 1 of this embodiment is an electronic control system and controls all of the above-described items. The control section 30 of this embodiment includes a processor such as CPU (not shown) and a storage device such as an ROM (Read Only Memory) or an RAM (Random Access Memory). In the storage device, a variety of programs, data, etc. for controlling the above-described respective items are stored. Further, the storage device has a work area for temporarily storing data in processing, processing results, etc. of various processes.

As shown in the example of FIGS. 2 and 4A, in the main body 10 of this embodiment, the spacer 14 is provided between the first heating section 12 and the second heating section 13. The spacer 14 of this embodiment is a member that holds the first heating section 12 or the second heating section 13. By providing the spacer 14, a distance between the first heating section 12 and the second heating section 13 can be more accurately determined. That is, the positions of the first heating section 12 and the second heating section 13 with respect to the first region 111 and the second region 112 of the biochip 100, which will be described later, can be more accurately determined.

The material of the spacer 14 can be appropriately selected according to need, but is preferably a heat insulating material. Accordingly, effects of heat generated by the first heating section 12 and the second heating section 13, which mutually affect each other, can be reduced, and the control of the temperatures of the first heating section 12 and the second heating section 13 becomes easy. In the case where the spacer 14 is made of a heat insulating material, when the biochip 100 is fitted in the fitting section 11, the spacer 14 is preferably disposed so as to surround the biochip 100 in a region between the first heating section 12 and the second heating section 13. Accordingly, the release of heat from a region between the first heating section 12 and the second heating section 13 of the biochip 100 can be prevented, and therefore, the temperature of the biochip 100 is further stabilized. In this embodiment, the spacer 14 is made of a heat insulating material, and in the example shown in FIG. 4A, the fitting section 11 penetrates through the spacer 14. Accordingly, when the biochip 100 is heated by the first heating section 12 and the second heating section 13, the heat of the biochip 100 is hardly released, and therefore, the temperatures of the first region 111 and the second region 112 can be further stabilized.

The main body 10 of this embodiment includes the fixing plate 19. The fixing plate 19 is a member that holds the fitting section 11, the first heating section 12, and the second heating section 13. In the example shown in FIGS. 1B and 2, two fixing plates 19 are fitted in the flanges 16, and the first heating section 12, the second heating section 13, and the bottom plate 17 are fixed by the fixing plates 19. By the fixing plates 19, the strength of the structure of the main body 10 is increased, and therefore, it becomes difficult to cause breakage of the main body 10.

The thermal cycler 1 of this embodiment includes the lid 50. In the example shown in FIGS. 1A and 4A, the fitting section 11 is covered with the lid 50. By covering the fitting section 11 with the lid 50, when heating is performed by the first heating section 12, the release of heat from the main body 10 to the outside can be prevented, and therefore, the temperature in the main body 10 can be stabilized. The lid 50 may be fixed to the main body 10 by a fixing section 51. In this embodiment, the fixing section 51 is a magnet. As shown in the example of FIGS. 1B and 2, a magnet is provided on a surface of the main body 10 which comes into contact with the lid 50. Although not shown in FIGS. 1B and 2, a magnet is provided also for the lid 50 in a place with which the magnet of the main body 10 comes into contact. When the fitting section 11 is covered with the lid 50, the lid 50 is fixed to the main body 10 with a magnetic force. Accordingly, the lid 50 can be prevented from moving or being detached from the main body 10 when the main body 10 is driven by the driving mechanism 20. As a result, the temperature in the thermal cycler 1 can be prevented from changing due to the detachment of the lid 50, and therefore, it is possible to subject a reaction mixture 140, which will be described later, to a more accurate thermal cycle.

The main body 10 is preferably has a highly airtight structure. If the main body 10 has a highly airtight structure, air in the main body 10 is hardly released to the outside of the main body 10, and therefore, the temperature in the main body 10 is further stabilized. In this embodiment, as shown in FIG. 2, a space in the main body 10 is hermetically sealed by the two flanges 16, the bottom plate 17, the two fixing plates 19, and the lid 50.

It is preferred that the fixing plate 19, the bottom plate 17, the lid 50, and the flange 16 are formed using a heat insulating material. Accordingly, the release of heat from the main body 10 to the outside can be further prevented, and therefore, the temperature in the main body 10 can be further stabilized.

### 1-2. Thermal Cycling Process Using Thermal Cycler According to Embodiment

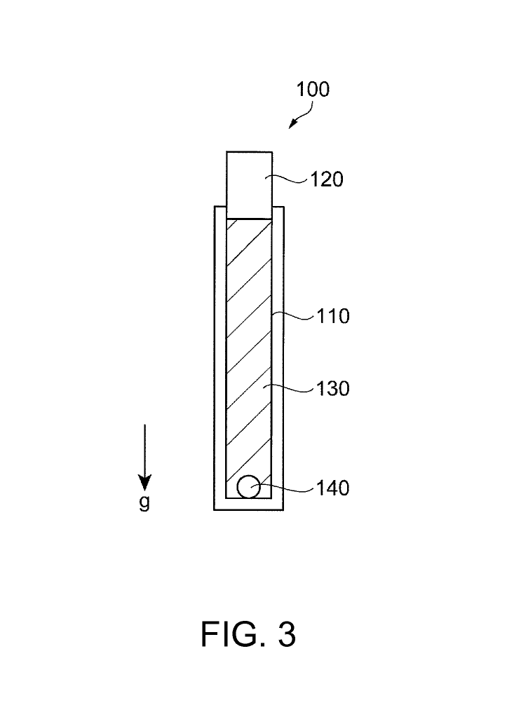

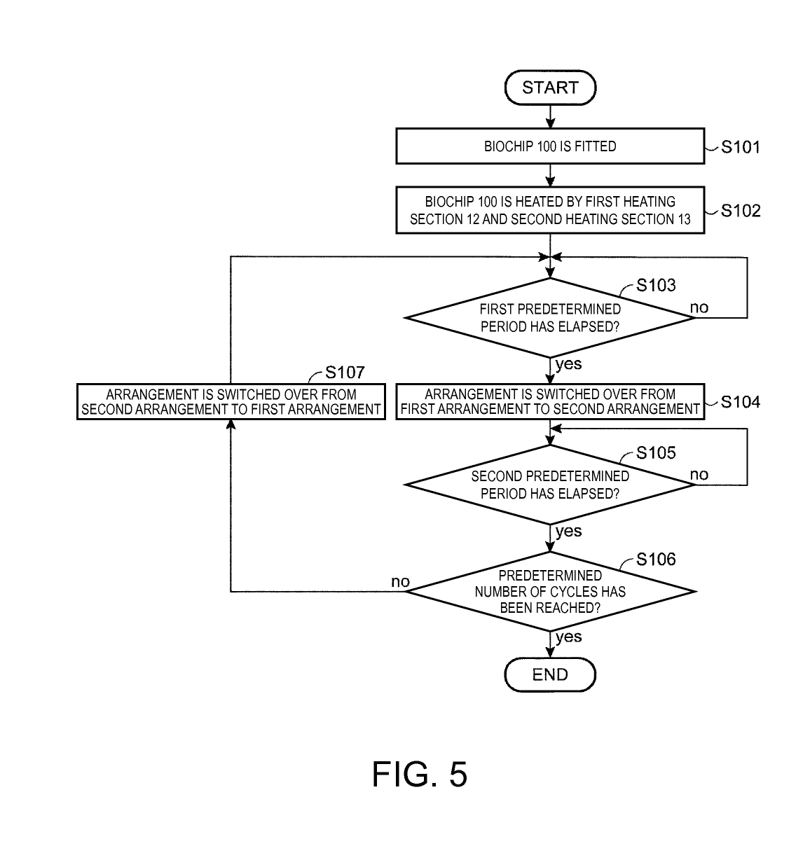

FIG. 3 is a cross-sectional view of the biochip 100 according to the embodiment. FIGS. 4A and 4B are schematic cross-sectional views showing the cross section taken along the line A-A in FIG. 1A of the thermal cycler 1 according to the embodiment. FIGS. 4A and 4B show a state in which the biochip 100 is fitted in the thermal cycler 1. FIG. 4A shows a first arrangement, and FIG. 4B shows a second arrangement. FIG. 5 is a flowchart showing a procedure of a thermal cycling process using the thermal cycler 1 according to the embodiment. Hereinafter, first, the biochip 100 according to the embodiment will be described, and then, the thermal cycling process using the thermal cycler 1 according to the embodiment in the case of using the biochip 100 will be described.

As shown in the example of FIG. 3, the biochip 100 according to the embodiment includes a flow channel 110 and a sealing section 120. The flow channel 110 is filled with a reaction mixture 140 and a liquid 130 which has a specific gravity smaller than the reaction mixture 140 and is immiscible with the reaction mixture 140 (hereinafter referred to as “liquid”), and sealed with the sealing section 120.

The flow channel 110 is formed such that the reaction mixture 140 moves in close proximity to opposed inner walls. Here, the term “opposed inner walls” of the flow channel 110 refers to two regions of a wall surface of the flow channel 110 having an opposed positional relationship. The phrase “in close proximity to” refers to a state in which the distance between the reaction mixture 140 and the wall surface of the flow channel 110 is short, and includes a case where the reaction mixture 140 is in contact with the wall surface of the flow channel 110. Therefore, the phrase “the reaction mixture 140 moves in close proximity to opposed inner walls” refers to that “the reaction mixture 140 moves in a state of being close in distance to both of the two regions of a wall surface of the flow channel 110 having an opposed positional relationship”, that is, the reaction mixture 140 moves along the opposed inner walls. In other words, the distance between the opposed two inner walls of the flow channel 110 is a distance enough to allow the reaction mixture 140 to move in close proximity to the inner walls.

If the flow channel 110 of the biochip 100 has the above-described form, the direction of the movement of the reaction mixture 140 in the flow channel 110 can be controlled, so that a route of the movement of the reaction mixture 140 between the first region 111 and the second region 112 which is different from the first region 111 in the flow channel 110, which will be described later, can be controlled to some extent. Accordingly, a period required for the reaction mixture 140 to move between the first region 111 and the second region 112 can be limited to some range. Therefore, the degree of “close proximity” is preferably a degree in which a variation in the period required for the reaction mixture 140 to move between the first region 111 and the second region 112 does not affect a heating period of the reaction mixture 140 in both regions, in other words, a degree in which the variation does not affect the result of the reaction. More specifically, the distance between the opposed inner walls in the direction perpendicular to the direction of the movement of the reaction mixture 140 is desirably a distance which does not allow two or more liquid droplets of the reaction mixture 140 to enter.

In the example shown in FIG. 3, the outer shape of the biochip 100 is a cylindrical shape, and the flow channel 110 is formed in the direction along a center axis (the vertical direction in FIG. 3) therein. The shape of the flow channel 110 is a tubular shape having a circular cross section in the direction perpendicular to the longitudinal direction of the flow channel 110, that is, in the direction perpendicular to the direction of the movement of the reaction mixture 140 in a region in the flow channel 110 (this cross section is defined as the “cross section” of the flow channel 110). Therefore, in the biochip 100 of this embodiment, the opposed inner walls of the flow channel 110 are regions including two points on the wall surface of the flow channel 110 constituting the diameter of the cross section of the flow channel 110, and the reaction mixture 140 moves in the longitudinal direction of the flow channel 110 along the opposed inner walls.

The first region 111 of the biochip 100 is a partial region of the flow channel 110 which is heated to the first temperature by the first heating section 12. The second region 112 is a partial region of the flow channel 110 which is different from the first region 111 and is heated to the second temperature by the second heating section 13. In the biochip 100 of this embodiment, the first region 111 is a region including one end portion in the longitudinal direction of the flow channel 110, and the second region 112 is a region including the other end portion in the longitudinal direction of the flow channel 110. In the example shown in FIGS. 4A and 4B, a region surrounded by the dotted line including an end portion on the proximal side of the sealing section 120 of the flow channel 110 is the second region 112, and a region surrounded by the dotted line including an end portion on the distal side of the sealing section 120 is the first region 111.

The flow channel 110 is filled with the liquid 130 and the reaction mixture 140. Since the liquid 130 is immiscible with the reaction mixture 140, that is, has a property that it is not mixed with the reaction mixture 140, the reaction mixture 140 is held in a state of a liquid droplet in the liquid 130 as shown in FIG. 3. The reaction mixture 140 is located in a lowermost portion of the flow channel 110 with respect to the gravitational direction because it has a specific gravity larger than the liquid 130. As the liquid 130, for example, dimethyl silicone oil or paraffin oil can be used. The reaction mixture 140 is a liquid containing components required for a reaction. When the reaction is PCR, the reaction mixture 140 contains a DNA (a target nucleic acid) to be amplified by PCR, a DNA polymerase required for amplifying the DNA, a primer, and the like. For example, when performing PCR using an oil as the liquid 130, the reaction mixture 140 is preferably an aqueous solution containing the above-described components.

Hereinafter, with reference to FIGS. 4A, 4B, and 5, the thermal cycling process using thermal cycler 1 according to the embodiment will be described. In FIGS. 4A and 4B, the direction indicated by the arrow g (in the downward direction in the drawing) is the gravitational direction. In this embodiment, a case where shuttle PCR (two-stage temperature PCR) is performed will be described as an example of the thermal cycling process. The respective steps described below are shown as an example of thermal cycling process, and according to need, the order of the steps may be changed, two or more steps may be performed continuously or concurrently, or a step may be added.

The shuttle PCR is a method of amplifying a nucleic acid in a reaction mixture by subjecting the reaction mixture to a two-stage temperature process between a high temperature and a low temperature repeatedly. In the process at a high temperature, denaturation of a double-stranded DNA is performed and in the process at a low temperature, annealing (a reaction in which a primer is bound to a single-stranded DNA) and an extension reaction (a reaction in which a complementary strand to the DNA is formed by using the primer as a starting point) are performed.

In general, in the shuttle PCR, the high temperature is a temperature between 80° C. and 100° C. and the low temperature is a temperature between 50° C. and 70° C. The processes at the respective temperatures are performed for a predetermined period, and a period of maintaining the reaction mixture at a high temperature is generally shorter than a period of maintaining the reaction mixture at a low temperature. For example, the period for the process at a high temperature may be about 1 to 10 seconds, and the period for the process at a low temperature may be about 10 to 60 seconds, or a period longer than this range may be adopted depending on the condition of the reaction.

Since the appropriate period, temperature, number of cycles (number of times of repetition of the process at a high temperature and the process at a low temperature) varies depending on the type or amount of a reagent to be used, it is preferred to determine an appropriate protocol in consideration of the type of a reagent or the amount of the reaction mixture 140 before performing the reaction.

First, the biochip 100 according to this embodiment is fitted in the fitting section 11 (Step S101). In this embodiment, the biochip 100, in which the reaction mixture 140 is introduced into the flow channel 110 previously filled with the liquid 130, and thereafter the flow channel 110 is sealed with the sealing section 120, is fitted in the fitting section 11. The introduction of the reaction mixture 140 can be performed using a micropipette, an ink-jet dispenser, or the like. In a state in which the biochip 100 is fitted in the fitting section 11, the first heating section 12 is in contact with the biochip 100 at a position including the first region 111 and the second heating section 13 is in contact with the biochip 100 at a position including the second region 112. In this embodiment, as shown in FIG. 4A, by fitting the biochip 100 in contact with the bottom plate 17, the biochip 100 can be held at a predetermined position with respect to the first heating section 12 and the second heating section 13.

In this embodiment, the arrangement of the fitting section 11, the first heating section 12, and the second heating section 13 in Step S101 is the first arrangement. The first arrangement is an arrangement in which the first region 111 is on the lower side of the second region 112 with respect to the gravitational direction. In this embodiment, as shown in FIG. 4A, the first arrangement is an arrangement in which the first region 111 of the biochip 100 is located in a lowermost portion of the flow channel 110 with respect to the gravitational direction. Therefore, when the fitting section 11, the first heating section 12, and the second heating section 13 are in a predetermined arrangement, the first region 111 is a partial region of the flow channel 110 located in a lowermost portion of the flow channel 110 with respect to the gravitational direction. In the first arrangement, the first region 111 is located in a lowermost portion of the flow channel 110 with respect to the gravitational direction, and therefore, the reaction mixture 140 having a specific gravity larger than the liquid 130 is located in the first region 111. In this embodiment, after the biochip 100 is fitted in the fitting section 11, the fitting section 11 is covered with the lid 50, and then the thermal cycler 1 is activated. In this embodiment, when the thermal cycler 1 is activated, Step S102 and Step S103 are started.

In Step S102, the biochip 100 is heated by the first heating section 12 and the second heating section 13. The first heating section 12 and the second heating section 13 heat different regions of the biochip 100 to different temperatures. That is, the first heating section 12 heats the first region 111 to the first temperature, and the second heating section 13 heats the second region 112 to the second temperature. Accordingly, a temperature gradient in which the temperature gradually changes between the first temperature and the second temperature is formed between the first region 111 and the second region 112 of the flow channel 110. In this embodiment, the first temperature is a relatively high temperature among the temperatures suitable for the intended reaction in the thermal cycling process, and the second temperature is a relatively low temperature among the temperatures suitable for the intended reaction in the thermal cycling process. Therefore, in Step S102 of this embodiment, a temperature gradient in which the temperature is decreased from the first region 111 to the second region 112 is formed. The thermal cycling process of this embodiment is the shuttle PCR, and therefore, the first temperature is preferably a temperature suitable for the denaturation of a double-stranded DNA, and the second temperature is preferably a temperature suitable for the annealing and the extension reaction.

Since the arrangement of the fitting section 11, the first heating section 12, and the second heating section 13 in Step S102 is the first arrangement, when the biochip 100 is heated in Step S102, the reaction mixture 140 is heated to the first temperature. Therefore, in Step S102, the reaction at the first temperature is performed for the reaction mixture 140.

In Step S103, it is determined whether or not the first period has elapsed in the first arrangement. In this embodiment, this determination is performed by the control section 30 (not shown). The first period is a period in which the fitting section 11, the first heating section 12, and the second heating section 13 are held in the first arrangement. In this embodiment, when Step S103 is performed subsequent to the fitting in Step S101, in other words, when the Step S103 is performed for the first time, it is determined whether or not the period from when the thermal cycler 1 is activated has reached the first period. In the first arrangement, the reaction mixture 140 is heated to the first temperature, and therefore, the first period is preferably defined as a period in which the reaction mixture 140 is subjected to the reaction at the first temperature in the intended reaction. In this embodiment, the first period is preferably defined as a period required for the denaturation of a double-stranded DNA.

In Step S103, if it is determined that the first period has elapsed (yes), the process proceeds to Step S104. If it is determined that the first period has not elapsed (no), Step S103 is repeated.

In Step S104, the main body 10 is driven by the driving mechanism 20, and the arrangement of the fitting section 11, the first heating section 12, and the second heating section 13 is switched over from the first arrangement to the second arrangement. The second arrangement is an arrangement in which the second region 112 is on the lower side of the first region 111 with respect to the gravitational direction. In this embodiment, as shown in FIG. 4B, the second arrangement is an arrangement in which the second region 112 is located in a lowermost portion of the flow channel 110 with respect to the gravitational direction. In other words, the second region 112 is a region located in a lowermost portion of the flow channel 110 with respect to the gravitational direction when the fitting section 11, the first heating section 12, and the second heating section 13 are in a predetermined arrangement different from the first arrangement.

In Step S104 of this embodiment, the arrangement of the fitting section 11, the first heating section 12, and the second heating section 13 is switched over from the state of FIG. 4A to the state of FIG. 4B. In the thermal cycler 1 of this embodiment, by the control of the control section 30, the driving mechanism 20 rotatively drives the main body 10. When the flanges 16 are rotatively driven by the motor by using the drive shaft as the axis of rotation, the fitting section 11, the first heating section 12, and the second heating section 13 which are fixed to the flanges 16 are rotated. Since the drive shaft is a shaft extending in the direction perpendicular to the longitudinal direction of the fitting section 11, when the drive shaft is rotated by the activation of the motor, the fitting section 11, the first heating section 12, and the second heating section 13 are rotated. In the example shown in FIGS. 4A and 4B, the main body 10 is rotated at 180°. By doing this, the arrangement of the fitting section 11, the first heating section 12, and the second heating section 13 is switched over from the first arrangement to the second arrangement.

In Step S104, the positional relationship between the first region 111 and the second region 112 with respect to the gravitational direction is opposite from that of the first arrangement, and therefore, the reaction mixture 140 moves from the first region 111 to the second region 112 by the gravitational force. After the arrangement of the fitting section 11, the first heating section 12, and the second heating section 13 has reached the second arrangement, when the control section 30 stops the operation of the driving mechanism 20, the fitting section 11, the first heating section 12, and the second heating section 13 are held in the second arrangement. After the arrangement of the fitting section 11, the first heating section 12, and the second heating section 13 has reached the second arrangement, Step S105 is started.

In Step S105, it is determined whether or not the second period has elapsed in the second arrangement. The second period is a period in which the fitting section 11, the first heating section 12, and the second heating section 13 are held in the second arrangement. In this embodiment, since the second region 112 has been heated to the second temperature in Step S102, in Step S105 of this embodiment, it is determined whether or not the second period has been reached from when the arrangement of the fitting section 11, the first heating section 12, and the second heating section 13 has reached the second arrangement. In the second arrangement, the reaction mixture 140 is held in the second region 112, and therefore, the reaction mixture 140 is heated to the second temperature during a period in which the main body 10 is held in the second arrangement. Accordingly, the second period is preferably defined as a period in which the reaction mixture 140 is heated to the second temperature in the intended reaction. In this embodiment, the second period is preferably defined as a period required for the annealing and the extension reaction.

In Step S105, if it is determined that the second period has elapsed (yes), the process proceeds to Step S106. If it is determined that the second period has not elapsed (no), Step S105 is repeated.

In Step S106, it is determined whether or not the number of thermal cycles has reached a predetermined number of cycles. Specifically, it is determined whether or not the procedure from Step S103 to Step S105 has been performed predetermined number of times. In this embodiment, the number of times that the procedure from Step S103 to Step S105 is completed is determined on the basis of the number of times that a determination as “yes” is made. When the procedure from Step S103 to Step S105 is performed once, the reaction mixture 140 is subjected to the thermal cycle once, and therefore, the number of times that the procedure from Step S103 to Step S105 is performed can be used as the number of thermal cycles. Accordingly, in Step S106, it can be determined whether or not the thermal cycle has been performed a necessary number of times for the intended reaction.

In Step S106, if it is determined that the thermal cycle has been performed a predetermined number of times (yes), the process is completed (END). If it is determined that the thermal cycle has not been performed a predetermined number of times (no), the process proceeds to Step S107.

In Step S107, the arrangement of the fitting section 11, the first heating section 12, and the second heating section 13 is switched over from the second arrangement to the first arrangement. By driving the main body 10 by the driving mechanism 20, the arrangement of the fitting section 11, the first heating section 12, and the second heating section 13 can be switched over to the first arrangement. After the arrangement of the fitting section 11, the first heating section 12, and the second heating section 13 has reached the first arrangement, Step S103 is started.

When Step S103 is performed subsequent to Step S107, in other words, in Step S103 for the second time and subsequent times, it is determined whether or not the first period has been reached from when the arrangement of the fitting section 11, the first heating section 12, and the second heating section 13 has reached the first arrangement.

The control section 30 preferably controls the driving mechanism 20 such that the direction of rotation in the case of switching over from the first arrangement to the second arrangement is opposite to that in the case of switching over from the second arrangement to the first arrangement. By doing this, the direction of rotation by the driving mechanism 20 in the case of switching over from the first arrangement to the second arrangement is opposite to that in the case of switching over from the second arrangement to the first arrangement, and therefore, a mechanism for reducing twisting of a wiring in the apparatus caused by the rotation is no longer required. Accordingly, a thermal cycler 1 suitable for downsizing can be realized.

### 1-3. Effect of Thermal Cycler According to Embodiment

According to the thermal cycler 1 of this embodiment, the following effects can be obtained.

According to the thermal cycler 1, the position of the lowermost point or the uppermost point of the biochip 100 with respect to the gravitational direction is changed by switching over between the first arrangement and the second arrangement. By changing the position in this manner, the reaction mixture 140 moves in the biochip 100. Therefore, the reaction mixture 140 placed in the biochip 100 can be subjected to a thermal cycle. Further, by providing the first temperature setting section (e.g., the first heating section 12) and the second temperature setting section (e.g., the second heating section 13) whose temperatures are different from each other, the temperature condition can be easily set. Further, while the driving mechanism 20 is keeping the arrangement of the biochip 100 in the first arrangement or the second arrangement, the reaction mixture 140 placed in the biochip 100 can be held at a predetermined temperature. Accordingly, the thermal cycler 1 which can easily control the period in which the reaction mixture 140 placed in the biochip 100 is held under a predetermined temperature condition can be realized.

### 2. MODIFICATION EXAMPLES

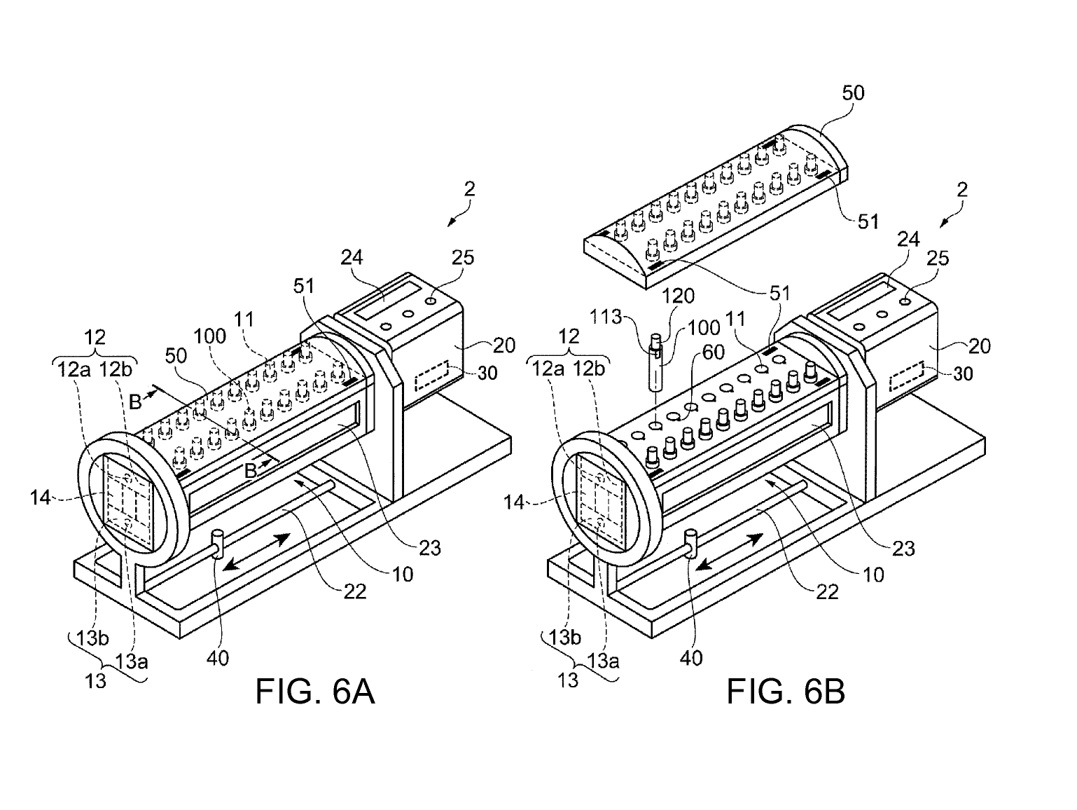

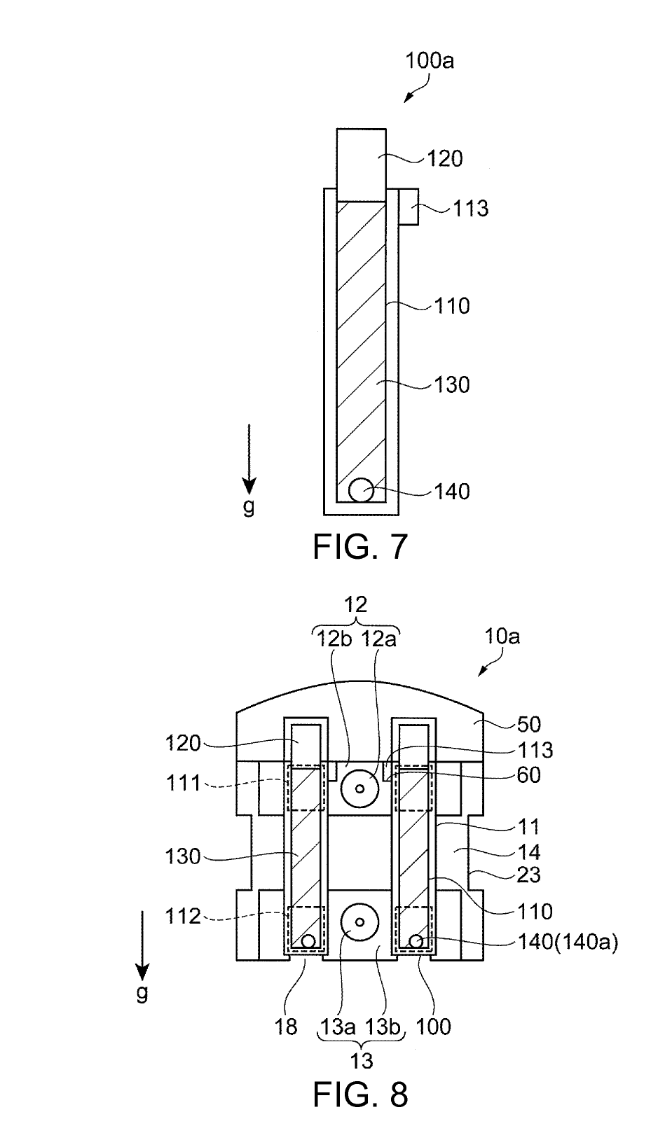

Hereinafter, modification examples will be described with reference to the embodiment. FIGS. 6A and 6B are perspective views showing a thermal cycler 2 according to a modification example. FIG. 6A shows a state in which a lid 50 is closed, and FIG. 6B shows a state in which the lid 50 is opened. FIG. 7 is a cross-sectional view of a biochip 100a according to Modification Example 4. FIG. 8 is a schematic cross-sectional view showing the cross section taken along the line B-B in FIG. 6A of a main body 10a of the thermal cycler according to the modification example. The following modification examples can be arbitrarily combined as long as their configurations are consistent with each other, and the thermal cycler 2 shown in FIGS. 6A, 6B, and 8 is an example of combining the configurations of Modification Examples 1, 4, 16, and 17. These modification examples will be described with reference to FIGS. 6A to 8. In the following description, components different from those of the embodiment will be described in detail, and the same components as those of the embodiment will be denoted by the same reference signs and the description thereof will be omitted.

### Modification Example 1

In the embodiment, the example in which the thermal cycler 1 does not include a detection device is shown, however, as shown in FIGS. 6A and 6B, the thermal cycler 2 according to this modification example may include a fluorescence detector 40. Accordingly, the thermal cycler 2 can be used in, for example, an analysis involving fluorescence detection such as real-time PCR. The number of the fluorescence detectors 40 is arbitrary as long as the detection can be performed without problems. In this modification example, a single fluorescence detector 40 is moved along a slide 22 to perform fluorescence detection. In order to perform fluorescence detection, it is preferred to provide a measurement window 18 (see FIG. 8) on the side of the second heating section 13 of the main body 10a. Accordingly, the number of members existing between the fluorescence detector 40 and the reaction mixture 140 can be reduced, and therefore, more appropriate fluorescence measurement can be achieved.

In this modification example, in the thermal cycler 2 shown in FIGS. 6A, 6B, and 8, the first heating section 12 is provided on the proximal side of the lid 50, and the second heating section 13 is provided on the distal side of the lid 50. That is, the positional relationship among the first heating section 12, the second heating section 13, and the other members included in the main body 10 is different from that of the thermal cycler 1. The functions of the first heating section 12 and the second heating section 13 are the same as in the first embodiment except that the positional relationship is different. In this modification example, as shown in FIG. 8, the measurement window 18 is provided for the second heating section 13. Accordingly, in the real-time PCR in which fluorescence measurement is performed on the side of a low temperature (a temperature at which annealing and an extension reaction are performed), the fluorescence measurement can be appropriately performed. In the case where fluorescence measurement is performed on the side of the lid 50, it is preferred to make a design such that a sealing section 120 and the lid 50 do not affect the measurement.

### Modification Example 2

In the embodiment, the first temperature and the second temperature are set to be a constant value throughout the thermal cycling process, however, at least either one of the first temperature and the second temperature may be changed during the process. The first temperature or the second temperature can be changed by, for example, the control of the control section 30. By switching over the arrangement of the first heating section 12 and the fitting section 11 to move the reaction mixture 140, the reaction mixture 140 can be heated to a temperature after changing. Therefore, for example, a reaction which requires a combination of two or more temperatures such as reverse transcription-PCR (RT-PCR, the outline of the reaction will be described in Examples) can be performed without increasing the number of heating sections or complicating the structure of the apparatus.

### Modification Example 3

In the embodiment, the example in which the fitting section 11 has a slot structure is shown, however, the structure of the fitting section 11 may be any as long as the fitting section 11 can hold the biochip 100. For example, a structure in which the biochip 100 is fitted into a recess formed to be fitted for the shape of the biochip 100 or a structure in which the biochip 100 is held by pinching may be adopted.

### Modification Example 4

In the embodiment, the structure that defines the position of the biochip 100 is the bottom plate 17, however, the structure that defines the position may be any as long as the biochip 100 can be held at a desired position. The structure that defines the position may be a structure provided for the thermal cycler 2 or a structure provided for the biochip 100 or a combination of both. For example, a screw, a plug-in stick, a structure in which a protrusion is provided for the biochip 100, or a structure in which the fitting section 11 and the biochip 100 are engaged with each other can be adopted. In the case of using a screw or a stick, such a structure may be configured such that the position of the biochip 100 to be held can be adjusted according to the reaction condition of the thermal cycle, the size of the biochip 100, etc. by changing the length of the screw or the insertion length of the screw, or changing the insertion position of the stick.

As the structure in which the biochip 100 and the fitting section 11 are engaged with each other, for example, as shown in FIGS. 6A, 6B, 7 and 8, a structure in which a protrusion 113 provided for the biochip 100 is fitted into a recess 60 provided for the fitting section 11 can be adopted. By doing this, the direction of the biochip 100 with respect to the first heating section 12 or the second heating section 13 can be kept constant. Accordingly, the direction of the biochip 100 can be prevented from changing during the thermal cycle, and therefore, heating can be more precisely controlled. As a result, the reaction mixture 140 can be subjected to a more accurate thermal cycle.

### Modification Example 5

In the embodiment, the example in which the first heating section 12 and the second heating section 13 are each a cartridge heater is shown, however, the first heating section 12 and the second heating section 13 may be any as long as the first heating section 12 can heat the first region 111 to the first temperature and the second heating section 13 can heat the second region 112 to the second temperature. For example, as the first heating section 12 and the second heating section 13, a carbon heater, a sheet heater, an IH (induction heater), a Peltier device, a heating liquid, or a heating gas can be used. In addition, different heating mechanisms may be adopted as the first heating section 12 and the second heating section 13.

### Modification Example 6

In the embodiment, the example in which the biochip 100 is heated by the first heating section 12 and the second heating section 13 is shown, however, a cooling section that cools the first region 111 may be provided as the first temperature setting section, or a cooling section that cools the second region 112 may be provided as the second temperature setting section. As the cooling section, for example, a Peltier device can be used. Accordingly, for example, even in the case where it is difficult to decrease the temperature of the second region 112 due to heat from the first region 111 of the biochip 100, a desired temperature gradient can be formed in the flow channel 110. Further, for example, it is possible to subject the reaction mixture 140 to a thermal cycle in which heating and cooling are repeated.

### Modification Example 7

In the embodiment, the example in which the material of the first heat block 12b and the second heat block 13b is aluminum is shown, however, the material of the heat blocks can be selected in consideration of the condition such as thermal conductivity, heat retention, or processability. For example, a copper alloy may be used, or a plurality of materials may be used in combination. Further, the first heat block 12b and the second heat block 13b may be made of a different material.

### Modification Example 8

As shown in the embodiment, in the case where the fitting section 11 is formed as a part of the first heating section 12, a mechanism for bringing the biochip 100 into close contact with the fitting section 11 may be provided. Such a mechanism may be any as long as it can brings at least a portion of the biochip 100 into close contact with the fitting section 11. For example, with a spring provided for the main body 10 or the lid 50, the biochip 100 may be pressed against one of the wall surfaces of the fitting section 11. Accordingly, heat of the first heating section 12 can be more stably transferred to the biochip 100, and therefore, the temperature of the biochip 100 can be further stabilized.

### Modification Example 9

In the embodiment, the example in which the temperatures of the first heating section 12 and the second heating section 13 are controlled to be substantially the same as the temperatures to which the biochip 100 is heated is shown, however, the control of the temperatures of the first heating section 12 and the second heating section 13 are not limited to the embodiment. The temperatures of the first heating section 12 and the second heating section 13 may be any temperatures as long as they are controlled so that the first region 111 and the second region 112 of the biochip 100 are heated to a desired temperature. For example, by considering the material and the size of the biochip 100, the first region 111 and the second region 112 can be more accurately heated to a desired temperature.

### Modification Example 10

In the embodiment, the example in which the driving mechanism 20 is a motor is shown, however, the driving mechanism 20 may be any as long as it is a mechanism capable of driving the fitting section 11, the first heating section 12, and the second heating section 13. In the case where the driving mechanism 20 is a mechanism that rotates the fitting section 11, the first heating section 12, and the second heating section 13, it is preferred that the driving mechanism 20 can control the rotation speed to such an extent that the temperature gradient of the liquid 130 is not destroyed by the centrifugal force. In addition, in order to eliminate twisting of a wiring, it is preferred that the driving mechanism 20 can reverse the direction of rotation. As such a mechanism, for example, a handle, a spring, etc. can be adopted.

### Modification Example 11

In the embodiment, the example in which the fitting section 11 is a part of the first heating section 12, however, the fitting section 11 and the first heating section 12 may be separate members as long as the positional relationship between both members does not change when the driving mechanism 20 is operated. In the case where the fitting section 11 and the first heating section 12 are separate members, both members are preferably fixed to each other directly or through another member. In addition, the fitting section 11 and the first heating section 12 may be driven by the same mechanism or by different mechanisms, but are preferably operated such that the positional relationship between both members is kept constant. Accordingly, when the driving mechanism 20 is operated, the positional relationship between the fitting section 11 and the first heating section 12 can be kept constant, and therefore, a predetermined region of the biochip 100 can be heated to a predetermined temperature. Incidentally, in the case where the fitting section 11, the first heating section 12, and the second heating section 13 are driven by different mechanisms, the different mechanisms are collectively referred to as the driving mechanism 20.

### Modification Example 12

In the embodiment, the example in which the temperature sensor is a thermocouple is shown, however, for example, a resistance temperature detector or a thermistor may be used.

### Modification Example 13

In the embodiment, the example in which the fixing section 51 is a magnet is shown, however, the fixing section 51 may be any as long as it can fix the lid 50 and the main body 10. For example, a hinge or a catch clip may be adopted.

### Modification Example 14

In the embodiment, the direction of the drive shaft is set to be perpendicular to the longitudinal direction of the fitting section 11, but is arbitrary as long as it can switch over the arrangement of the fitting section 11, the first heating section 12, and the second heating section 13 between the first arrangement and the second arrangement. In the case where the driving mechanism 20 is a mechanism that rotatively drives the fitting section 11, the first heating section 12, and the second heating section 13, the arrangement of the fitting section 11, the first heating section 12, and the second heating section 13 can be switched over by using a line which is not in parallel with the longitudinal direction of the fitting section 11 as the axis of rotation.

### Modification Example 15

In the embodiment, the example in which the control section 30 is an electronic control system is shown, however, the control section 30 that controls the first period and the second period (a period control section) can be any as long as it can control the first period and the second period. That is, it can be any as long as it can control the timing of operation and stopping of the driving mechanism 20. In addition, the control section 30 that controls the number of thermal cycles (a cycle number control section) may be any as long as it can control the number of thermal cycles. As the period control section and the cycle number control section, for example, a physical mechanism or an electronic control mechanism, or a combination thereof can be adopted.

### Modification Example 16

The thermal cycler may include a setting section 25 as shown in FIGS. 6A and 6B. The setting section 25 is a UI (user interface), and is a device that sets the condition of the thermal cycle. By operating the setting section 25, at least one of the first temperature, the second temperature, the first period, the second period, and the number of thermal cycles can be set. The setting section 25 and the control section 30 are mechanically or electronically interlocked with each other, and the setting in the setting section 25 is reflected in the control of the control section 30. Accordingly, the condition of the reaction can be changed, and therefore, the reaction mixture 140 can be subjected to a desired thermal cycle. The setting section 25 may be configured such that any one of the above-described items can be individually set, or that when, for example, one reaction condition is selected from a plurality of previously registered reaction conditions, necessary items are automatically set. In the example shown in FIGS. 6A and 6B, the setting section 25 uses a button system, and by pushing a button among buttons provided for individual items, the reaction condition can be set.

### Modification Example 17

The thermal cycler may include a display section 24 as shown in FIGS. 6A and 6B. The display section 24 is a display device, and displays various items of information relating to the thermal cycler. The display section 24 may display the condition set by the setting section 25 or the actual period or temperature during the thermal cycling process. For example, when the setting is performed, an input condition is displayed, and during the thermal cycling process, a temperature measured by the temperature sensor, an elapsed period in the first arrangement or the second arrangement, or the number of thermal cycles performed may be displayed. Also, when the thermal cycling process is completed, or when any abnormality occurs in the apparatus, such an event may be displayed. Further, a voice-guided notification may also be performed. By performing the display or the voice-guided notification, a user of the apparatus can easily ascertain the progress status or completion of the thermal cycling process.

### Modification Example 18

In the embodiment, the biochip 100 in which the flow channel 110 has a circular cross section is shown as an example, however, the shape of the flow channel 110 is arbitrary as long as the reaction mixture 140 can move in close proximity to opposed inner walls. In other words, the shape of the flow channel 110 is arbitrary as long as a variation in a period in which the reaction mixture 140 moves between the first region 111 and the second region 112 does not affect a heating period of the reaction mixture 140 in both regions. In the case where the cross section of the flow channel 110 of the biochip 100 has a polygonal shape, the term “opposed inner walls” refers to opposed inner walls of a hypothetical flow channel which has a circular cross section internally in contact with the flow channel 110. That is, the cross section of the flow channel 110 may have any shape as long as the flow channel 110 is configured such that the reaction mixture 140 moves in close proximity to opposed inner walls of a hypothetical flow channel which has a circular cross section internally in contact with the flow channel 110. Accordingly, even in the case where the cross section of the flow channel 110 has a polygonal shape, the route of the movement of the reaction mixture 140 between the first region 111 and the second region 112 can be controlled to some extent. As a result, a period required for the reaction mixture 140 to move between the first region 111 and the second region 112 can be limited to some range.

### Modification Example 19

In the embodiment, the liquid 130 is defined as a liquid having a specific gravity smaller than the reaction mixture 140, however, the liquid 130 may be any as long as it is a liquid which is immiscible with the reaction mixture 140 and has a specific gravity different from the reaction mixture 140. For example, a liquid which is immiscible with the reaction mixture 140 and has a specific gravity larger than the reaction mixture 140 may be adopted. In the case where the liquid 130 has a specific gravity larger than the reaction mixture 140, the reaction mixture 140 is located in an uppermost portion of the flow channel 110 with respect to the gravitational direction.

### Modification Example 20

In the embodiment, the direction of rotation in Step S104 and the direction of rotation in Step S107 are opposite to each other. However, after the rotation in the same direction is performed a plurality of times, the rotation in the opposite direction may be performed the same number of times. By doing this, twisting of a wiring can be eliminated, and therefore, deterioration of the wiring can be reduced as compared with the case where the rotation in the opposite direction is not performed.

### Modification Example 21

The thermal cycler 1 according to the embodiment includes the first heating section 12 and the second heating section 13, however, the second heating section 13 may not be included. That is, as the heating section, only the first heating section 12 may be provided. Accordingly, the number of members to be used can be reduced, and therefore, the production cost can be reduced.

In this modification example, by heating the first region 111 of the biochip 100 by the first heating section 12, a temperature gradient in which the temperature gradually decreases with distance from the first region 111 is formed in the biochip 100. Since the second region 112 is a region different from the first region 111, the temperature thereof is maintained at the second temperature which is lower than that of the first region 111. In this modification example, the second temperature is controlled by, for example, the design of the biochip 100, the property of the liquid 130, the setting of the temperature of the first heating section 12, etc.

In this modification example, by switching over the arrangement of the fitting section 11 and the first heating section 12 between the first arrangement and the second arrangement by the driving mechanism 20, the reaction mixture 140 can be moved between the first region 111 and the second region 112. Since the first region 111 and the second region 112 are maintained at different temperatures, it is possible to subject the reaction mixture 140 to a thermal cycle.

In the case where the second heating section 13 is not provided, the spacer 14 holds the first heating section 12. Accordingly, the position of the first heating section 12 in the main body 10 can be more accurately defined, and therefore, the first region 111 can be more reliably heated. In the case where the spacer 14 is made of a heat insulating material, by arranging the spacer 14 to surround the region of the biochip 100 other than the region to be heated by the first heating section 12, the temperatures of the first region 111 and the second region 112 can be further stabilized.

The thermal cycler of this modification example may have a mechanism for keeping the temperature of the main body constant. Accordingly, the temperature of the second region 112 of the biochip 100 is further stabilized, and therefore, it is possible to subject the reaction mixture 140 to a more accurate thermal cycle. As the mechanism for keeping the temperature of the main body 10 constant, for example, a thermoregulated bath can be used.

### Modification Example 22

In the embodiment, the example in which the thermal cycler 1 includes the lid 50 is shown, however, the lid 50 may not be included. Accordingly, the number of members to be used can be reduced, and therefore, the production cost can be reduced.

### Modification Example 23

In the embodiment, the example in which the thermal cycler 1 includes the spacer 14 is shown, however, the spacer 14 may not be included. Accordingly, the number of members to be used can be reduced, and therefore, the production cost can be reduced.

### Modification Example 24

In the embodiment, the example in which the thermal cycler 1 includes the bottom plate 17 is shown, however, as shown in FIG. 8, the bottom plate 17 may not be included. Accordingly, the number of members to be used can be reduced, and therefore, the production cost can be reduced.

### Modification Example 25

In the embodiment, the example in which the thermal cycler 1 includes the fixing plate 19 is shown, however, the fixing plate 19 may not be included. Accordingly, the number of members to be used can be reduced, and therefore, the production cost can be reduced.

### Modification Example 26

In the embodiment, the example in which the spacer 14 and the fixing plate 19 are separate members is shown, however, as shown in FIG. 8, the spacer 14 and the fixing plate 19 may be formed integrally. Further, the bottom plate 17 and the spacer 14, or the bottom plate 17 and the fixing plate 19 may be formed integrally.

### Modification Example 27

The spacer 14 and the fixing plate 19 may be made of a transparent material. Accordingly, in the case where a transparent biochip 100 is used in the thermal cycling process, a manner in which the reaction mixture 140 moves can be observed from the outside of the apparatus. As a result, it can be visually confirmed whether or not the thermal cycling process is performed appropriately. Therefore, the degree of the “transparency” in this case may suffice if the movement of the reaction mixture 140 can be visually observed when the thermal cycling process is performed using these members in the thermal cycler 2.

### Modification Example 28

In order to observe the inner portion of the thermal cycler 2, the thermal cycler 2 may be configured such that the spacer 14 is made of a transparent material and the fixing plate 19 is omitted, or the fixing plate 19 is made of a transparent material and the spacer 14 is omitted, or both of the spacer 14 and the fixing plate 19 are omitted. As the number of members existing between an observer and the biochip 100 to be observed is decreased, the effect of the members on light refraction is decreased, and therefore, it becomes easy to observe the inner portion. Further, as the number of members is small, the production cost can be reduced.

### Modification Example 29

In order to observe the inner portion of the thermal cycler 2, as shown in FIGS. 6A, 6B and 8, an observation window 23 may be provided for the main body 10a. The observation window 23 may be, for example, a hole or a slit formed in the spacer 14 or the fixing plate 19. In the example shown in FIG. 8, the observation window 23 is a recess provided for the transparent spacer 14 formed integrally with the fixing plate 19. By providing the observation window 23, the thickness of the members existing between an observer and the biochip 100 to be observed can be decreased, and therefore, it becomes easy to observe the inner portion.

### Modification Example 30

In the embodiment, the example in which the first heating section 12 is disposed on the side of the bottom plate 17 of the main body 10, and the second heating section 13 is disposed on the side of the lid 50 is shown, however, as shown in FIG. 8, the first heating section 12 may be disposed on the side of the lid 50. In the case where the first heating section 12 is disposed on the side of the lid 50, the arrangement of the fitting section 11, the first heating section 12, and the second heating section 13 when the biochip 100 is fitted in Step S101 in the embodiment is the second arrangement. That is, the second region 112 is located in a lowermost portion of the flow channel 110 with respect to the gravitational direction. Accordingly, in the case where the thermal cycler 2 of this modification example is applied to the thermal cycling process according to the embodiment, when the biochip 100 is fitted in the fitting section 11, the arrangement is switched over to the first arrangement. Specifically, before the process proceeds from Step S101 to Step S102 and Step S103, a process of Step S107 is performed.

### Modification Example 31

In the embodiment, the example in which the step of heating the biochip 100 by the first heating section 12 and the second heating section 13 (Step S102) and the step of determining whether or not the first period has elapsed (Step S103) are started after the biochip 100 is fitted in the fitting section 11 (Step S101) is shown, however, the timing of starting Step S102 is not limited to the embodiment. Step S102 may be started at any timing as long as the first region 111 is heated to the first temperature by the time when the period measurement is started in Step S103. The timing of performing Step S102 is determined in consideration of the size or the material of the biochip 100 to be used, a period required for heating the first heat block 12b, etc. For example, Step S102 may be started before Step S101, or concurrently with Step S101, or may be started after Step S101 and before Step S103.

### Modification Example 32

In the embodiment, the example in which the first temperature, the second temperature, the first period, the second period, the number of thermal cycles, and the operation of the driving mechanism 20 are controlled by the control section 30 is shown, however, a user can control at least one of these items. In the case where a user controls the first temperature or the second temperature, for example, a temperature measured by the temperature sensor is displayed on the display section 24, and the user may adjust the temperature by operating the setting section 25. In the case where a user controls the number of thermal cycles, the user stops the thermal cycler 2 when the number of thermal cycles has reached a predetermined number of cycles. The counting of the thermal cycles may be performed by the user or by the thermal cycler 2 and the number of thermal cycles may be displayed on the display section 24.

In the case where a user controls the first period or the second period, the user determines whether or not a predetermined period has been reached and causes the thermal cycler 2 to switch over the arrangement of the fitting section 11, the first heating section 12, and the second heating section 13. That is, the user performs Step S103 and Step S105 and at least a part of Step S104 and Step S107 shown in FIG. 5. The period may be measured using a timer which is not interlocked with the thermal cycler 2 or the elapsed time may be displayed on the display device 24 of the thermal cycler 2. The switching over of the arrangement may be performed by operating the setting section 25 (UI) or manually performed by employing a handle in the driving mechanism 20.

### Modification Example 33

In the embodiment, the example in which the angle of rotation when the arrangement of the fitting section 11, the first heating section 12, and the second heating section 13 is switched over by the rotation of the driving mechanism 20 is 180° is shown, however, the angle of rotation may be any angle as long as the vertical positional relationship between the first region 111 and the second region 112 with respect to the gravitational direction is changed. For example, if the angle of rotation is less than 180°, the speed of movement of the reaction mixture 140 is decreased. Therefore, by adjusting the angle of rotation, the period in which the reaction mixture 140 moves between the first region 111 at the first temperature and the second region 112 at the second temperature can be adjusted. That is, a period in which the temperature of the reaction mixture 140 changes between the first temperature and the second temperature can be adjusted.

### 3. EXAMPLES

Hereinafter, the invention will be more specifically described with reference to Examples, however, the invention is not limited thereto.

### Example 1

### Shuttle PCR

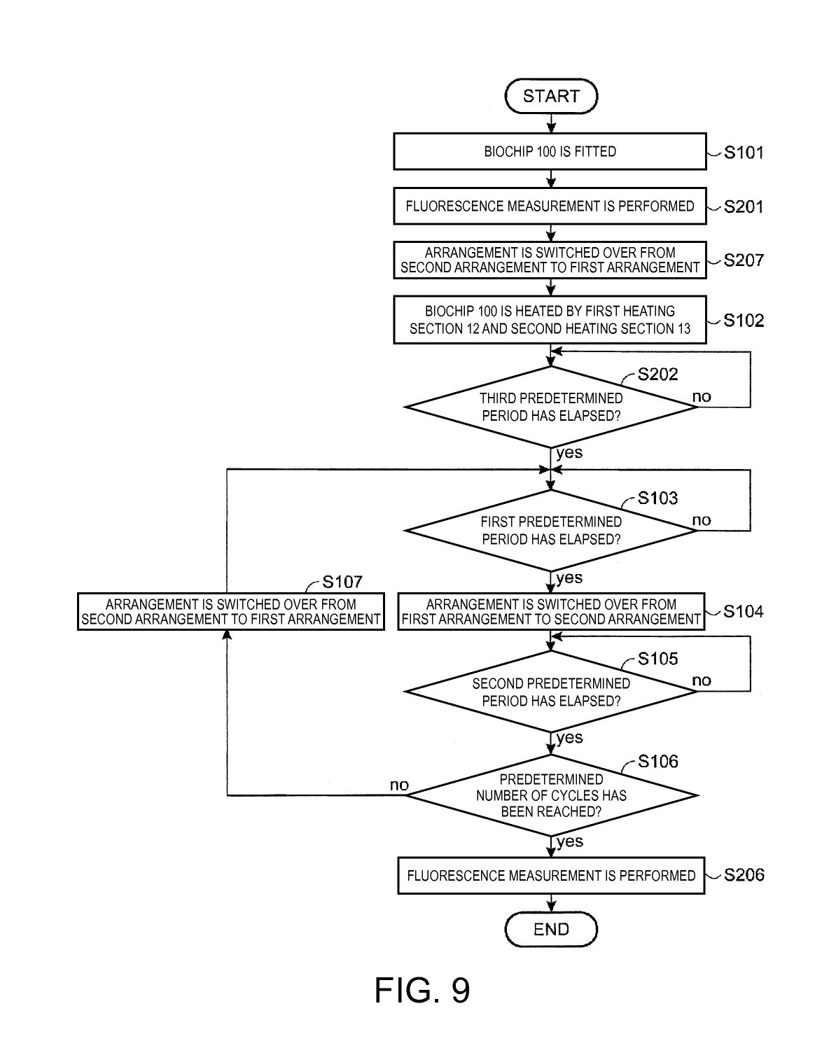

In this Example, the shuttle PCR involving fluorescence measurement using the thermal cycler 2 according to the modification example 1 will be described with reference to FIG. 9. However, the above-described embodiment and respective modification examples may be used. FIG. 9 is a flowchart showing a procedure of a thermal cycle in this Example. In comparison with the flowchart in FIG. 5, the flowchart in FIG. 9 is different from the flowchart in FIG. 5 in that Step S201 and Step S202 are included. The fluorescence detector 40 in this Example is FLE1000 (manufactured by Nippon Sheet Glass Co., Ltd.).

The biochip 100 of this Example has a cylindrical outer shape, and has a flow channel 110 in the shape of a cylinder with an inner diameter of 2 mm and a length of 25 mm. The biochip 100 is formed from a polypropylene resin having heat resistance at a temperature of 100° C. or higher. The flow channel 110 is filled with dimethyl silicone oil (KF-96L-2cs, manufactured by Shin-Etsu Silicone Co., Ltd.) in an amount of about 130 μL. A reaction mixture 140a in this Example is a mixture of 1 μL of human β-actin DNA (the amount of DNA is 10³ copy/μL), 10 μL of PCR master mix (GeneAmp® Fast PCR Master Mix (2×), manufactured by Applied Biosystems, Inc.), 1 μL of a primer and probe mix (Pre-Developed TagMan® Assay Reagents Human ACTB, manufactured by Applied Biosystems, Inc.), and 8 μL of PCR water (water, PCR Grade, manufactured by Roche Diagnostics GmbH). As the DNA, a cDNA obtained by reverse transcription of commercially available total RNA (qPCR Human Reference Total RNA, manufactured by Clontech, Inc.) was used.

First, 1 μL of the reaction mixture 140a was introduced into the flow channel 110 using a micropipette. Since the reaction mixture 140a is an aqueous solution, it is not mixed with dimethyl silicone oil described above. Therefore, the reaction mixture 140a was held in the form of a liquid droplet having a spherical shape with a diameter of about 1.5 mm in the liquid 130. Further, since the specific gravity of the above-described dimethyl silicone oil is about 0.873 at 25° C., the reaction mixture 140a (having a specific gravity of about 1.0) was located in a lowermost portion of the flow channel 110 with respect to the gravitational direction. Subsequently, one end portion of the flow channel 110 was sealed with a plug and a thermal cycling process was started.

First, the biochip 100 of this Example is fitted in the fitting section 11 of the thermal cycler 2 (Step S101). In this Example, fourteen of the above-described biochips 100 were used. At this time, the arrangement of the fitting section 11 and the first heating section 12 is the second arrangement, and the reaction mixture 140a is located in the second region 112, that is, on the side of the second heating section 13. After the fitting section 11 is covered with the lid 50 and the thermal cycler 2 is operated, Step S201 is performed.

In Step S201, fluorescence measurement is performed by the fluorescence detector 40. In this Example, in the second arrangement, the measurement window 18 and the fluorescence detector 40 face each other. Therefore, when the fluorescence detector 40 is operated in the second arrangement, the fluorescence measurement is performed through the measurement window 18. In this Example, by moving the fluorescence detector 40 along the slide 22, the measurement was performed sequentially for the plurality of biochips 100. In Step S201, after the measurement for all of the biochips 100 is completed, Step S207 is performed. In this Example, after the fluorescence measurement is completed through all of the measurement windows 18, the process proceeds to Step S207.

In Step S207, the arrangement is switched over from the second arrangement to the first arrangement. That is, Step S207 is substantially the same as Step S107 in the embodiment. Accordingly, the fitting section 11, the first heating section 12, and the second heating section 13 are held in the first arrangement, and therefore, the reaction mixture 140a moves to the first region 111.

Subsequently, Step S102 and Step S202 are started. In Step S102, the biochip 100 is heated by the first heating section 12 and the second heating section 13. In this Example, the first temperature is 95° C., and the second temperature is 66° C. Accordingly, a temperature gradient in which the temperature gradually decreases from 95° C. to 66° C. is formed from the first region 111 to the second region 112 in the biochip 100. In Step S102, the reaction mixture 140a is in the first region 111, and therefore is heated to 95° C.

In Step S202, it is determined whether or not the third period has elapsed in the first arrangement. With the size of the biochip 100 in this Example, a period from when the heating is started until when the temperature gradient is formed is a negligible level, and therefore, the measurement of the third period may be started simultaneously with the start of heating. The third predetermined period in this Example is 10 seconds, and in Step S202, hot start of PCR is performed. The hot start is a process of activating a DNA polymerase contained in the reaction mixture 140a by heat to bring it in a state capable of amplifying a DNA. If it is determined that a period of 10 seconds has not elapsed (no), Step S202 is repeated. If it is determined that a period of 10 seconds has elapsed (yes), the process proceeds to Step S103.

In Step S103, it is determined whether or not the first predetermined period has elapsed in the first arrangement. In this Example, the first period is one second. That is, denaturation of a double-stranded DNA is performed at 95° C. for one second. Step S202 and Step S103 are each a process performed at the first temperature, and therefore, in the case of performing Step S202, and then performing Step S103, the activation of the polymerase and denaturation of the DNA substantially proceed in parallel with each other. In Step S103, it is determined whether or not a period of one second has elapsed in the first arrangement. If it is determined that a period of one second has not elapsed (no), Step S103 is repeated. If it is determined that a period of one second has elapsed (yes), the main body 10a is rotated by the driving mechanism 20 so that the second region 112 of the biochip 100 is located in a lowermost portion with respect to the gravitational direction (Step S104). By doing this, the reaction mixture 140a moves from a region at 95° C. to a region at 66° C. in the flow channel 110 by the gravitational action. In this Example, a period required for the rotation in Step S104 is three seconds, and the reaction mixture 140a moves to the second region 112 during this period. By the control of the control section 30, the driving mechanism 20 stops the operation when the second arrangement has been reached, and Step S105 is started.

In Step S105, it is determined whether or not the second predetermined period has elapsed in the second arrangement. In this Example, the second period is 15 seconds. That is, annealing and an extension reaction are performed at 66° C. for 15 seconds. In Step S105, it is determined whether or not a period of 15 seconds has elapsed in the second arrangement. If it is determined that a period of 15 seconds has not elapsed (no), Step S105 is repeated. If it is determined that a period of 15 seconds has elapsed (yes), subsequently, it is determined whether or not the number of thermal cycles has reached a predetermined number of cycles (Step S106). In this Example, the predetermined number of cycles is 50. That is, it is determined whether or not the procedure from Step S103 to Step S105 has been performed 50 times. If the number of cycles is less than 50, it is determined that the predetermined number of cycles has not been reached (no), and the process proceeds to Step S107.

In Step S107, the main body 10a is rotated by the driving mechanism 20 so that the first region 111 of the biochip 100 is located in a lowermost portion with respect to the gravitational direction. By doing this, the reaction mixture 140a moves from a region at 66° C. to a region at 95° C. in the flow channel 110 by the gravitational action. By the control of the control section 30, the driving mechanism 20 stops the operation when the first arrangement has been reached, and a second thermal cycle is started. That is, a procedure from Step S103 to Step S106 is repeated. In Step S106, if it is determined that the thermal cycles have been performed 50 times (yes), fluorescence measurement is performed (Step S206), and then, heating is stopped to complete the thermal cycling process.

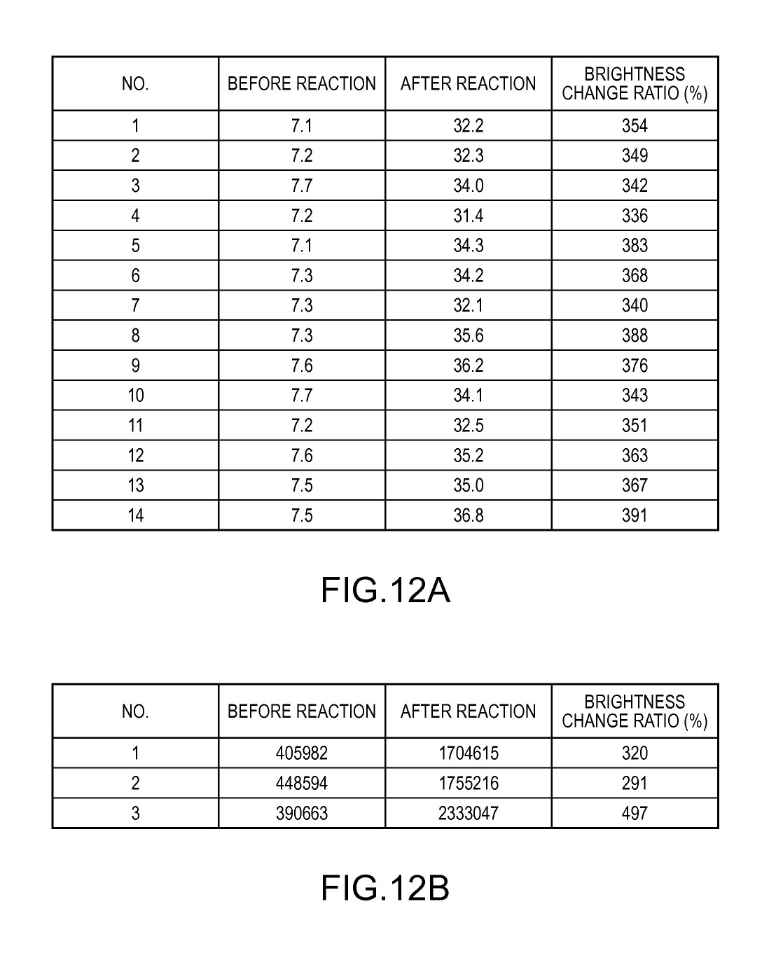

The results of the fluorescence measurement performed twice (Step S201 and Step S206) are shown in FIG. 12A. The fluorescence brightness (intensity) before performing the thermal cycling process is shown as “before reaction”, and the fluorescence brightness after performing the thermal cycle the predetermined number of times is shown as “after reaction”. A brightness change ratio (%) is a value calculated according to the following formula (1).

(brightness change ratio)=100×{(after reaction)−(before reaction)}/(before reaction) (1)

The probe used in this Example is TaqMan probe. This probe has a property such that the fluorescence brightness to be detected is increased as the nucleic acid is amplified. As shown in FIG. 12A, the fluorescence brightness of the reaction mixture 140a was increased after performing the thermal cycling process in comparison with the fluorescence brightness before performing the thermal cycling process. The calculated brightness change ratio is a value indicating that the nucleic acid has been sufficiently amplified, and it could be confirmed that the nucleic acid was amplified by the thermal cycler 2 of this Example.

In this Example, first, the reaction mixture 140a is maintained at 95° C. for one second, and then, by rotating the main body 10a at 180 degrees by the driving mechanism 20, the reaction mixture 140a can be maintained at 66° C. for 15 seconds. Then, by rotating the main body 10a at 180 degrees again by the driving mechanism 20, the reaction mixture 140a can be maintained at 95° C. again. That is, by switching over the arrangement of the fitting section 11, the first heating section 12, and the second heating section 13 by the driving mechanism 20, the reaction mixture 140a can be held in the first arrangement or the second arrangement for a desired period. Accordingly, also in the case where the first period and the second period are different in the thermal cycling process, the heating period can be easily controlled, and therefore, it is possible to subject the reaction mixture 140a to a desired thermal cycle.

In this Example, the heating period at the first temperature is one second, the heating period at the second temperature is 15 seconds, and a period required for moving the reaction mixture 140a between the first region 111 and the second region 112 is 3 seconds (6 seconds for back and forth movement), and therefore, a period required for one cycle is 22 seconds. Accordingly, in the case where the number of cycles is 50, the thermal cycling process including the hot start can be completed for about 19 minutes.

### Example 2

### 1-Step RT-PCR

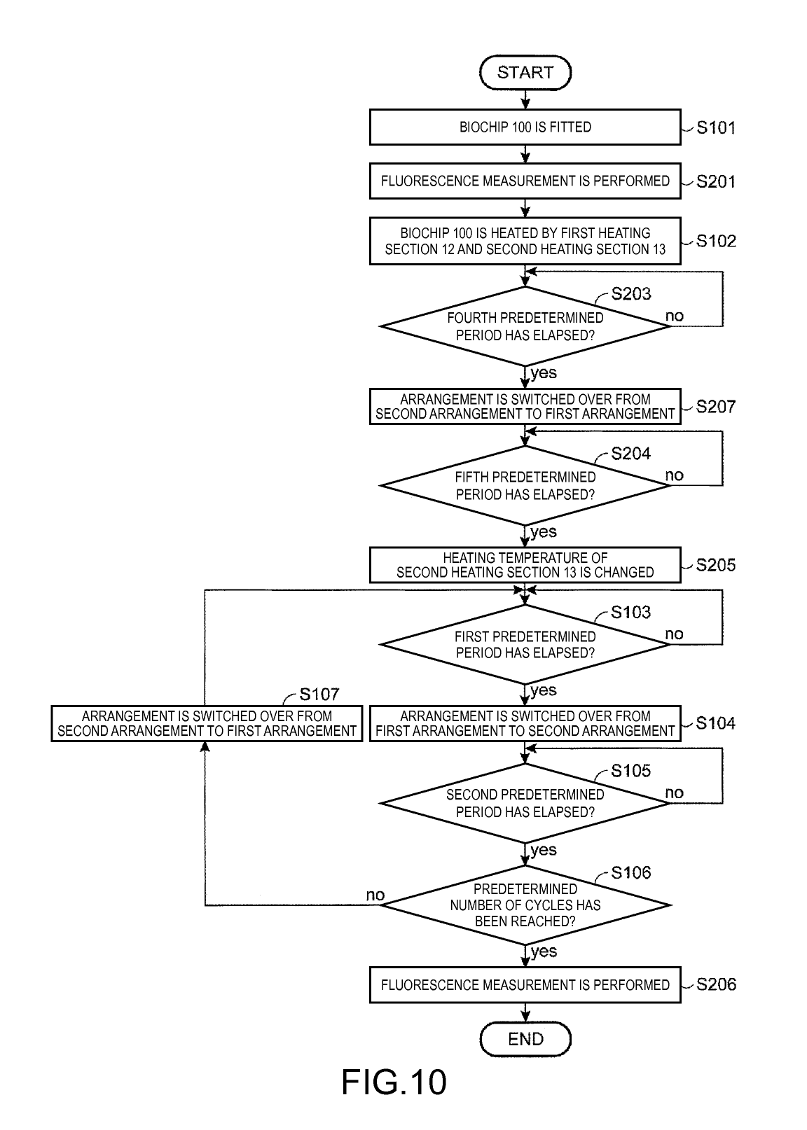

In this Example, 1-step RT-PCR using the thermal cycler according to the modification examples 1 and 2 will be described with reference to FIG. 10. FIG. 10 is a flowchart showing a procedure of a thermal cycle according to this Example. The thermal cycler of this Example is the same as the thermal cycler 2 of Example 1 except that the temperature of the second heating section 13 can be changed during the process. The other configurations can be implemented in the same manner even if any of the above-described modification examples is applied. The fluorescence detector 40 in this Example is 2104 EnVision Multi Label counter (manufactured by PerkinElmer, Inc.).

RT-PCR (a reverse transcription-polymerase chain reaction) is a method of performing detection or quantitative determination of an RNA. Reverse transcription is performed from an RNA used as a template to a DNA at 45° C. using a reverse transcriptase and a cDNA synthesized by the reverse transcription is amplified by PCR. In the general RT-PCR, the process of the reverse transcription reaction and the process of the PCR are independent and a chamber is exchanged or a reagent is added between the process of the reverse transcription and the process of the PCR. In contrast, in the 1-step RT-PCR, the reverse transcription and the reaction of the PCR are performed continuously by using a specific reagent. This Example employs the 1-step RT-PCR, and therefore is different from the process of the shuttle PCR in Example 1 in that the process for performing the reverse transcription (from Step S203 to Step S204) and the process for transferring to the shuttle PCR (Step S205) are performed in comparison of the process of the shuttle PCR in Example 1 with the process of this Example.

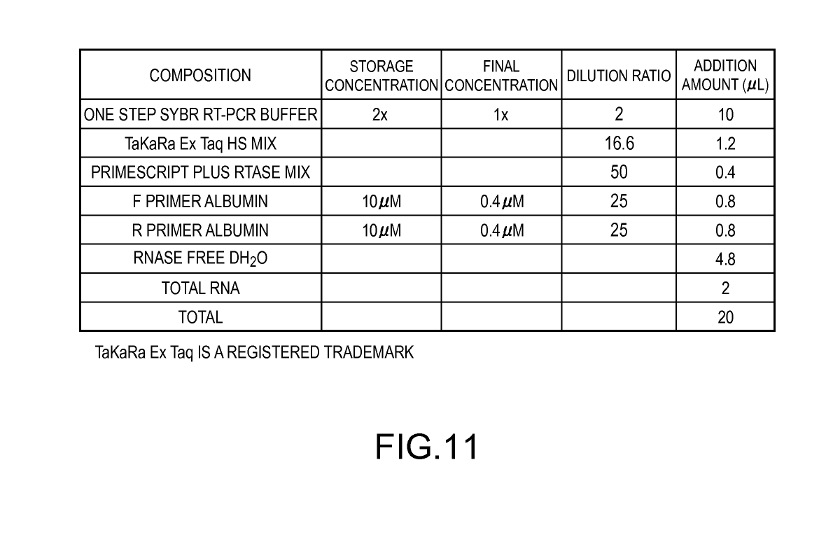

The biochip 100 of this Example is the same as that of Example 1 except that the components contained in a reaction mixture 140b are different. As the reaction mixture 140b, a reaction mixture prepared to have the composition shown in FIG. 11 using a commercially available kit for 1-step RT-PCR (One Step SYBR® PrimeScript® PLUS RT-PCR kit, manufactured by TAKARA BIO, Inc.).

In the same manner as in Example 1, three of the biochips 100 into which the reaction mixture 140b was introduced were used, and the reaction was performed. First, in Step S101, the biochips 100 are fitted in the fitting section 11. When the thermal cycler is operated, Step S201 is performed. By doing this, the fluorescence brightness of the reaction mixture 140b before performing the thermal cycling process is measured.

Subsequently, Step S102 and Step S203 are started. In Step S102 of this Example, the first region 111 of the biochip 100 is heated to 95° C. by the first heating section 12, and the second region 112 is heated to 42° C. by the second heating section 13. In this Example, the arrangement of the fitting section 11, the first heating section 12, and the second heating section 13 in Step S101 is the second arrangement. Accordingly, the reaction mixture 140b is in the second region 112, and therefore is heated to 42° C. and the reverse transcription from an RNA to a DNA is performed.

In Step S203, it is determined whether or not a fourth period has elapsed in the second arrangement. That is, Step S203 is the same as Step S105 except that the length of the period to be determined is different. The fourth period in this Example is 300 seconds. In Step S203, if it is determined that a period of 300 seconds has not elapsed (no), Step S203 is repeated, and if it is determined that a period of 300 seconds has elapsed (yes), the process proceeds to Step S207.

In Step S207, the arrangement of the fitting section 11, the first heating section 12, and the second heating section 13 is switched over from the second arrangement to the first arrangement, and then, Step S204 is started.

In Step S204, it is determined whether or not a fifth period has elapsed in the first arrangement. Step S204 is the same as Step S103 except that the length of the period to be determined is different. The fifth period in this Example is 10 seconds. Since the first region 111 has been heated to 95° C., the reaction mixture 140b which has moved to the first region 111 in Step S207 is heated to 95° C. By heating the reaction mixture 140b at 95° C. for 10 seconds, the reverse transcriptase is inactivated. In Step S204, if it is determined that a period of 10 seconds has not elapsed (no), Step S204 is repeated, and if it is determined that a period of 10 seconds has elapsed (yes), the process proceeds to Step S205.

Step S205 is a step of changing the temperature to which the biochip 100 is heated by the second heating section 13. In this Example, the biochip 100 is heated by the second heating section 13 such that the temperature of the second region 112 is increased to 60° C. By doing this, the first region 111 is heated to 95° C. and the second region 112 is heated to 60° C., and therefore a temperature gradient suitable for the shuttle PCR is formed in the flow channel 110 of the biochip 100. When the temperature of the second heating section 13 has been changed in Step S205, the process proceeds to Step S103.

In the case where the Step S103 is performed subsequent to Step S205, it is determined whether or not an elapsed time after completion of Step S205 has reached the first predetermined period. Step S103 may be started after a desired temperature has been reached by measuring the temperature with a temperature sensor. In this Example, a period required for changing the temperature is a negligible level, and therefore, Step S205 and Step S103 are started simultaneously. In the case where the Step S103 is performed subsequent to Step S107, Step S103 is performed in the same manner as in the embodiment and Example 1.

The process after Step S103 in this Example is the same as in Example 1 except that specific reaction condition for the thermal cycling process is different. By repeating the procedure from Step S103 to Step S107, the shuttle PCR is performed. Specifically, a thermal cycle of 95° C. for 5 seconds and 60° C. for 30 seconds is repeated 40 times through the same process as in Example 1, whereby a DNA is amplified.

The results of the fluorescence measurement performed twice (Step S201 and Step S206) are shown in FIG. 12B. A brightness change ratio was calculated in the same manner as in Example 1. The probe used in this Example is SYBR Green I. This probe also increases the fluorescence brightness to be detected as the nucleic acid is amplified. As shown in FIG. 12B, the fluorescence brightness of the reaction mixture 140b was increased after performing the thermal cycling process in comparison with the fluorescence brightness before performing the thermal cycling process. The calculated brightness change ratio is a value indicating that the nucleic acid has been sufficiently amplified, and it could be confirmed that the nucleic acid was amplified by the thermal cycler 2 of this Example.

In this Example, the reaction mixture 140b can be heated to a temperature changed by changing the heating temperature during the process. Accordingly, in addition to the same effect as that of Example 1 (shuttle PCR), an effect of being able to perform a process in which the heating temperatures are different using one apparatus without increasing the number of the heating sections or complicating the structure of the apparatus can be obtained. Further, a reaction in which the period of heating the reaction mixture 140b is required to be changed during the reaction can be performed without complicating the structure of the apparatus or the biochip by changing the period in which the biochip 100 is held in the first arrangement or the second arrangement.

The present invention is not limited to the embodiment described above, and various modifications may be made. For example, the invention includes substantially the same configuration as the configuration described in the embodiment (for example, the configuration in which the function, the method, and the result are the same, or the configuration having the same object and the effect). The invention also includes configurations in which a portion which is not essential in the configuration described in the embodiment is replaced. The invention also includes configurations which achieve the same effects and advantages as the configuration described in the embodiment, or configurations which are able to achieve the same object. The invention also includes configurations including known techniques added to the configuration described in the embodiment.

The entire disclosure of Japanese Patent Application No. 2012-129309, filed Jun. 6, 2012 is expressly incorporated by reference herein.

What is claimed is:

1. A thermal cycler comprising:
a fitting section for fitting a biochip;
a first temperature setting section that sets the temperature of a first region of the biochip;
a second temperature setting section that sets the temperature of a second region different from the first region of the biochip to a temperature different from the first temperature setting section;
a driving mechanism that changes a positional relationship between the first region and the second region with respect to the gravitational direction; and
a control section that controls the driving mechanism, wherein
the control section performs:
a process of controlling the driving mechanism such that a first arrangement in which the first region is on the lower side of the second region with respect to the gravitational direction is kept for a first predetermined period; and
a process of controlling the driving mechanism such that a second arrangement in which the second region is on the lower side of the first region with respect to the gravitational direction is kept for a second predetermined period.

2. The thermal cycler according to claim 1, wherein the control section controls the driving mechanism such that the direction of rotation in the case of switching over from the first arrangement to the second arrangement is opposite to that in the case of switching over from the second arrangement to the first arrangement.
